(19) United States
(12) Patent Application Publication
(10) Pub. No.: US 2010/0161687 A1
(43) Pub. Date: Jun. 24, 2010

(54) SYSTEM AND METHOD FOR OPTIMIZING GARBAGE COLLECTION WITH ALLOCATION MODIFIERS

(75) Inventors: Ralf Altrichter, Filderstadt (DE); Dirk Heuzeroth, Stuttgart (DE); Gerd Kehrer, Meckenheim (DE); Martin Raitza, Boeblingen (DE)

Correspondence Address: Greg Goshorn, P.C., 9600 Escarpment, Suite 745-9, AUSTIN, TX, 78749, US

(73) Assignee: INTERNATIONAL BUSINESS MACHINES CORPORATION, Armonk, NY (US)

(21) Appl. No.: 12/343,609

(22) Filed: Dec. 24, 2008

(51) Int. Cl. G06F 17/30

(52) U.S. Cl. 707/813; 707/E17.002

(57) ABSTRACT

A system and associated method for optimizing memory allocation and garbage collection. An allocation modifier is employed to declare a data object in a source code. The allocation modifier describes an expected lifespan of the data object being declared. The interpreter allocates the data object in an area of a heap space that is associated with the expected lifespan such that a garbage collector suffers from less overhead in scanning data objects that will survive a garbage collection cycle. Also, the heap space also has less fragmentation as the data object is allocated in the area associated with the expected lifespan such that the data object does not need to be relocated.

### FIELD OF THE INVENTION

The present invention discloses a system and associated method for improving performance of a computer program by reducing memory management overhead related to garbage collection.

### BACKGROUND OF THE INVENTION

Conventional garbage collection methods in virtual machines have substantial overhead to manage heap spaces in a heuristic manner. Conventional garbage collection methods in virtual machines scan objects in heap spaces and relocate survived objects to heap portions assigned to long-term objects. Information on lifespan of objects is gathered during garbage collection cycles by a garbage collector of a virtual machine. The fragmentation caused by relocation of objects during garbage collection diminishes performance of the virtual machine. A conventional solution to organize objects in heap spaces based on access relationships among objects pursuant to heuristic information gathered upon compilation or during runtime.

Thus, there is a need for a system and associated method that overcomes at least one disadvantage of conventional method for optimizing garbage collection in a virtual machine.

### SUMMARY OF THE INVENTION

The present invention provides a method for optimizing garbage collection, the method comprising:

interpreting an intermediate code comprising a data object declared with an allocation modifier that indicates how long the data object will be used while executing the intermediate code, wherein the allocation modifier is provided by a programmer of a source code which had been compiled into the intermediate code;

determining a heap area for the data object pursuant to the allocation modifier; and

allocating the data object in the determined heap area such that a garbage collector reduces the number of objects to scan during garbage collection and minimizes the number of objects to be relocated from a first heap area to a second heap area, wherein objects in the first heap area are younger than objects in the second heap area, wherein an interpreter of a runtime environment performs said interpreting, said determining, and said allocating, and wherein the runtime environment comprises the interpreter and the garbage collector.

The present invention provides a computer program product, comprising a computer usable storage medium having a computer readable program code embodied therein, said computer readable program code containing instructions that when executed by a processor of a computer system implement a method for optimizing garbage collection, the method comprising:

interpreting an intermediate code comprising a data object declared with an allocation modifier that indicates how long the data object will be used while executing the intermediate code, wherein the allocation modifier is provided by a programmer of a source code which had been compiled into the intermediate code;

determining a heap area for the data object pursuant to the allocation modifier; and

allocating the data object in the determined heap area such that a garbage collector reduces the number of objects to scan during garbage collection and minimizes the number of objects to be relocated from a first heap area to a second heap area, wherein objects in the first heap area are younger than objects in the second heap area,

wherein an interpreter of a runtime environment performs said interpreting, said determining, and said allocating, and wherein the runtime environment comprises the interpreter and the garbage collector.

The present invention provides a system comprising a processor and a computer readable memory unit coupled to the processor, said memory unit containing instructions that when executed by the processor implement a method for optimizing garbage collection, the method comprising:

interpreting an intermediate code comprising a data object declared with an allocation modifier that indicates how long the data object will be used while executing the intermediate code, wherein the allocation modifier is provided by a programmer of a source code which had been compiled into the intermediate code;

determining a heap area for the data object pursuant to the allocation modifier; and

allocating the data object in the determined heap area such that a garbage collector reduces the number of objects to scan during garbage collection and minimizes the number of objects to be relocated from a first heap area to a second heap area, wherein objects in the first heap area are younger than objects in the second heap area,

wherein an interpreter of a runtime environment performs said interpreting, said determining, and said allocating, and wherein the runtime environment comprises the interpreter and the garbage collector.

The present invention provides a method for optimizing garbage collection, the method comprising:

loading a machine code comprising a data object declared with an allocation modifier that indicates how long the data object will be used while executing the machine code, wherein the allocation modifier is provided by a programmer of the source code which had been compiled into the machine code;

determining a heap area for the data object pursuant to the allocation modifier; and

allocating the data object in the determined heap area such that a garbage collector reduces the number of objects to scan during garbage collection and minimizes the number of objects to be relocated from a first heap area to a second heap area, wherein objects in the first heap area are younger than objects in the second heap area,

wherein an execution engine of a runtime environment performs said loading, said determining, and said allocating, and wherein the runtime environment comprises the interpreter and the garbage collector

The present invention provides a method and system that overcomes at least one of the current disadvantages of conventional method and system for allocating data objects with garbage collection overheads.

### BRIEF DESCRIPTION OF THE DRAWINGS

FIG. 1 illustrates a system employed for optimizing garbage collection with allocation modifiers, in accordance with embodiments of the present invention.

FIG. 1A illustrates an alternative system for optimizing garbage collection with allocation modifiers, in accordance with embodiments of the present invention.

FIG. 2 illustrates an example of a source code with the allocation modifiers, in accordance with the embodiments of the present invention.

FIG. 3 is a flowchart depicting a garbage collection cycle performed by a garbage collector of a runtime environment, in accordance with the embodiments of the present invention.

FIGS. 4A, 4B, and 4C illustrate heap layouts by a conventional object allocation method at time t0, t1, and t2, respectively.

FIGS. 5A, 5B, and 5C illustrate heap layouts for objects created with a respective allocation modifier at time t0, t1, and t2, respectively, in accordance with the embodiments of the present invention.

FIG. 6 illustrates a computer system used for optimizing garbage collection with the allocation modifiers, in accordance with the embodiments of the present invention.

### DETAILED DESCRIPTION OF THE INVENTION

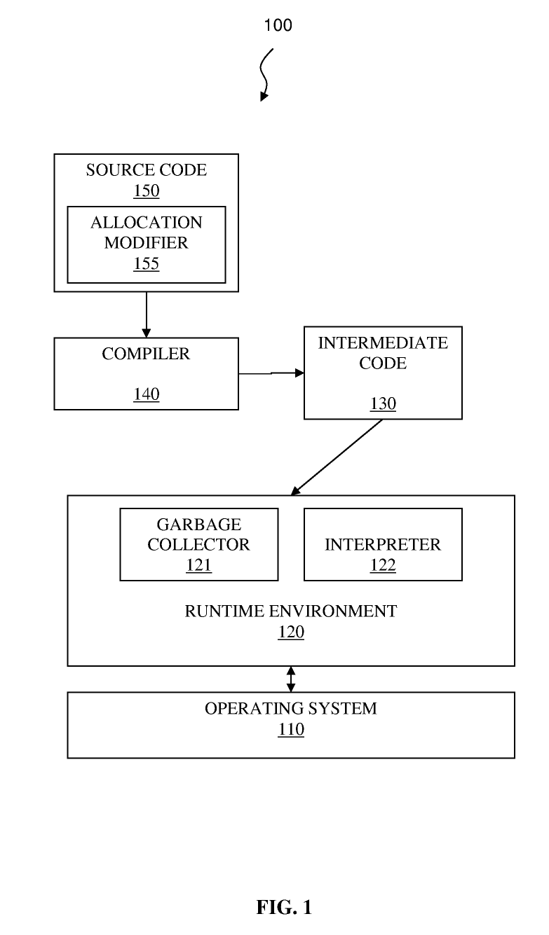

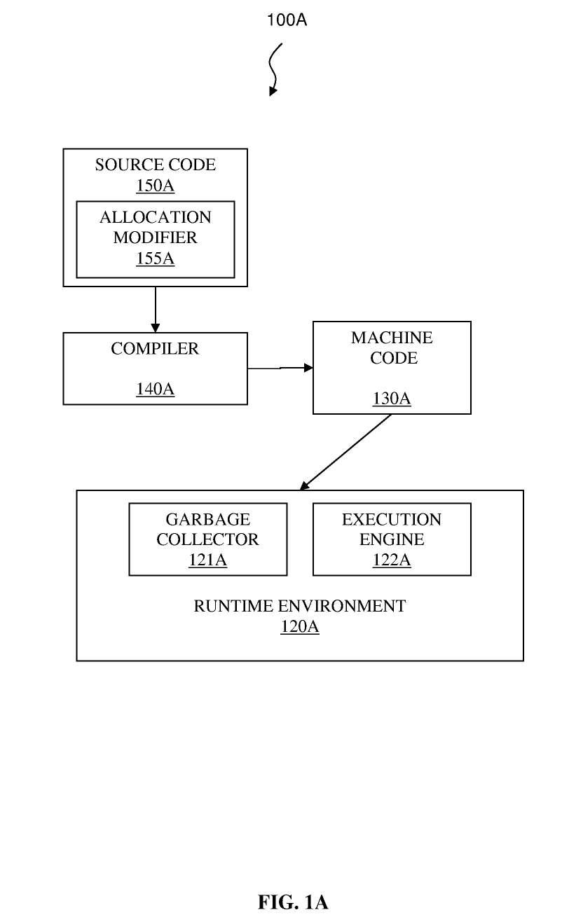

FIG. 1 illustrates a system 100 employed for optimizing garbage collection with allocation modifiers, in accordance with embodiments of the present invention.

The system 100 comprises a source code 150, a compiler 140, an intermediate code 130, a runtime environment 120, and an operation system 110.

The operating system 110 executes an instance of the runtime environment 120 and provides kernel services upon being requested by the runtime environment. Examples of the operating system may be, inter alia, Linux®, UNIX®, etc. (Linux is a registered trademark of Linus Torvals in the United States and other countries; UNIX is a registered trademark of X/Open Company Ltd., in the United States and other countries.)

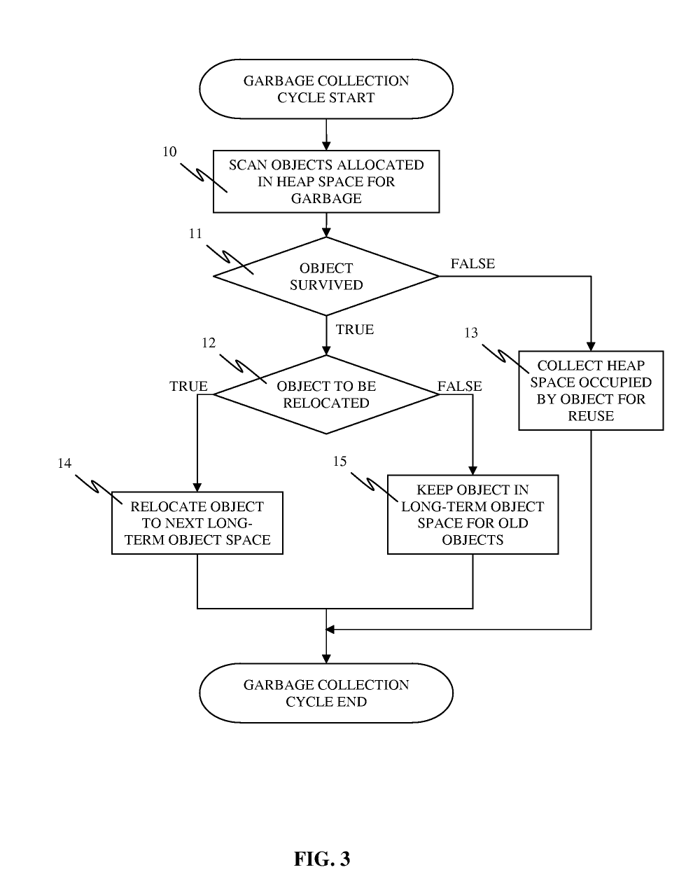

The runtime environment 120 comprises a garbage collector 121 and an interpreter 122. The garbage collector 121 collects dead data objects that are not used by the intermediate code 130 and makes heap spaces for the dead data objects available for reuse. See description of FIG. 3, infra, for a garbage collection cycle. The interpreter 122 allocates data objects in the intermediate code 130 and executes the intermediate code 130. An example of the runtime environment 120 may be, inter alia, the Java Virtual Machine (JVM®), etc. (JVM is a registered trademark of Sun Microsystems, Inc., in the United States and other countries.)

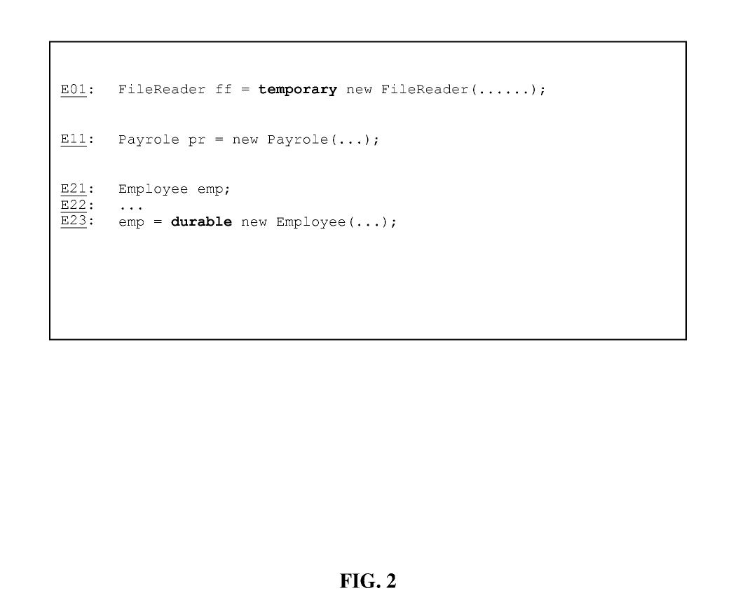

The source code 150 comprises at least one allocation modifier represented in a respective data object declaration. See FIG. 2, infra, for an example of the source code. The compiler 140 compiles the source code 150 into the intermediate code 130 that is executable by the interpreter 122. An allocation modifier 155 of said at least one allocation modifier is provided by a programmer in the source code 150 while declaring a data object with the allocation modifier 155 as a modifier for the compiler 140. The allocation modifier 155 is a set of optional key words in a programming language that indicates a life expectancy of a data object that is declared with the allocation modifier 155. An example of the programming language may be, inter alia, the Java®, etc. (Java is a registered trademark of Sun Microsystems, Inc., in the United States and other countries.)

The allocation modifier 155 is employed to organize the data object declared with the allocation modifier 155 such that the garbage collector 121 uses less garbage collection cycles in running the intermediate code 130. The allocation modifier 155 informs the runtime environment 120 a life expectancy of the data object and access relationships of the data object with other data objects as the programmer intended in a declaration of the data object with the allocation modifier 155. A lifespan of a data object is duration of time during which a memory space should be allocated for the object. A lifespan of a data object is determined by execution logic of a program in which the data object is created. Examples of execution logic may be, inter alia, algorithm of a program, input data, user interactions, etc.

The interpreter 122 allocates the data object directly in a portion of a heap space pursuant to the expected lifespan of the data object informed by the allocation modifier 155. A conventional heap space comprises a short term objects space referred to as “eden,” a survivor space, a long-term object space, and a permanent object space. A conventional interpreter allocates all data objects in the “eden” and a data object which had survived a garbage collection cycle is relocated to the survivor space. If a data object in the survivor space survives another garbage collection cycle, the data object is relocated to the long-term object space. System variables are allocated in the permanent object space.

The garbage collector 121 scans the heap space and relocates a surviving data object to a portion of the heap space for data objects with longer lifespan. The method of the present invention employs the conventional heap space and a conventional garbage collector, but reduces garbage collection cycle by reducing scanning overheads and relocating overheads by directly allocating the data object in a portion of the heap space that the data object remains during a lifespan of the data object.

In a first embodiment of the present invention, the allocation modifier 155 may be selected from {short, middle, long} wherein each modifier indicates that a data object declared with each modifier is expected to have a lifespan described by a respective modifier.

In a second embodiment of the present invention, the allocation modifier 155 may be selected from {temporary, durable, (null)}, wherein “temporary” and “durable” indicate that a data object declared with a respective modifier is expected to have a short lifespan and a long lifespan, respectively, and wherein a data object of which lifespan is difficult for the programmer to predict can be declared without the allocation modifier 155 such that the data object is treated as a conventional data object without the allocation modifier 155.

FIG. 1A illustrates an alternative system 100A for optimizing garbage collection with allocation modifiers, in accordance with embodiments of the present invention.

In this embodiment of the present invention, a runtime environment 120A is integrated with an operating system. A garbage collector 121A is a part of a kernel service for memory management of the operating system, and an execution engine 122A executes a machine code 130A within the runtime environment 120A. The execution engine 122A is a utility specialized for executing the machine code 130A. The machine code 130A is in a format executable in the runtime environment 120A, and a source code 150A may be written in, inter alia, C, C++, etc. An allocation modifier 155A of the source code 150A and a compiler 140A are analogous to the allocation modifier 155 and the compiler 140 of FIG. 1, supra.

FIG. 2 illustrates an example of a source code with the allocation modifiers, in accordance with the embodiments of the present invention.

The source code is written with allocation modifiers of the second embodiment of the present invention in FIG. 1, supra.

Line E01 illustrates a new data object FileReader ( ) is allocated in “eden” due to a short life expectancy indicated by the modifier “temporary.”

Line E11 illustrates a new data object Payrole ( ) is allocated in “eden” as in a conventional object allocation method because no allocation modifier is used.

Line E23 illustrates a new data object Employee ( ) is allocated in a long-term object space in a heap pursuant to a long life expectancy indicated by the allocation modifier “durable.”

FIG. 3 is a flowchart depicting a garbage collection cycle performed by a garbage collector of a runtime environment, in accordance with the embodiments of the present invention.

In step 10, the garbage collector scans objects allocated in a heap space to discover a dead object, i.e., garbage. The garbage collector first scans a short-term object area in a heap space which has the greatest dead objects in all heap spaces. Also, freeing multiple objects that are concentrated in a portion of the heap space reduces fragmentation resulting from garbage collection.

In step 11, the garbage collector determines whether an object in the heap space is still alive. If the garbage collector determines that the object in the heap space is still alive, the garbage collector proceeds with step 12. If the garbage collector determines that the object in the heap space is dead, the garbage collector proceeds with step 13.

In step 12, the garbage collector determines whether the object needs to be relocated within the heap space pursuant to a portion of the heap space in which the object has survived. The objects survived in a short-term object space or in a survivor space needs to be relocated to the survivor space or to a long-term object space, respectively. The object survived in the long-term object space remains in the long-term object space. If the garbage collector determines that the object needs to be relocated, the garbage collector proceeds with step 14. If the garbage collector determines that the object does not have to be relocated, the garbage collector proceeds with step 15.

In step 13, the garbage collector collects a memory space used by the dead object for reuse.

In step 14, the garbage collector relocates the objects survived in the short-term object space or in the survivor space to the survivor space or to the long-term object space, respectively.

Partitioning objects by age is a common technique used by generational garbage collectors to reduce fragmentation and scanning overhead to find out dead objects. During a garbage collection cycle, wherein there is enough free memory to allocate new objects in the short-term object space, the garbage collector does not scan the survivor space and the long-term object space.

In step 15, the garbage collector keeps the survived object in the long-term object space for old objects in the same place.

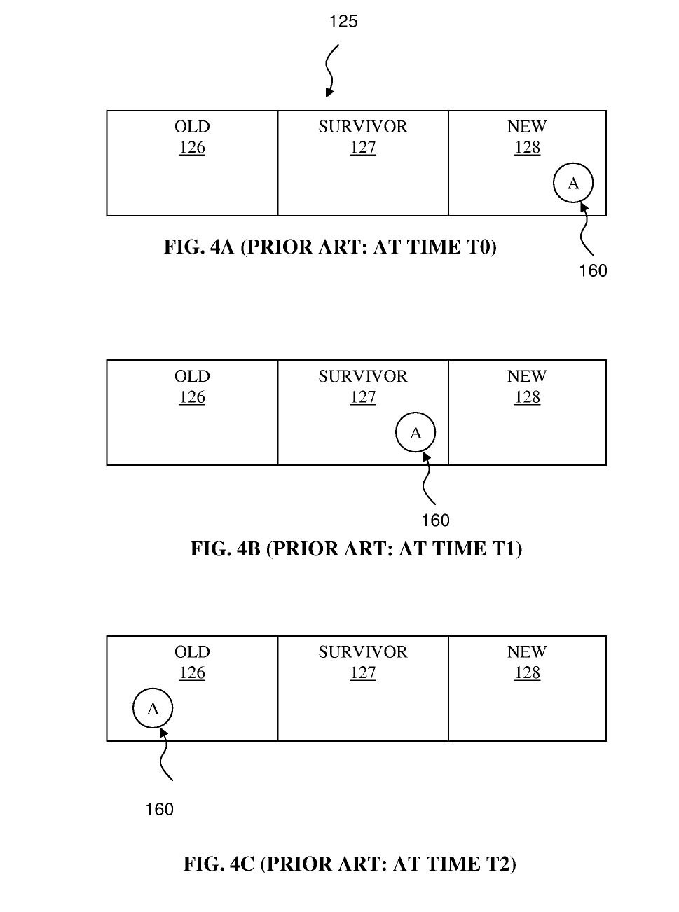

FIGS. 4A, 4B, and 4C illustrate heap layouts by a conventional object allocation method at time t0, t1, and t2, respectively.

In FIG. 4A, an object A 160 is allocated in a “new” area 128 in a heap space 125 at time t0, when the object A 160 is first created.

In FIG. 4B, an object A 160 is relocated to a “survivor” area 127 in the heap space 125 at time t1, when the object A 160 has survived a first garbage collection cycle.

In FIG. 4C, an object A 160 is relocated to an “old” area 126 in the heap space 125 at time t2, when the object A 160 has survived another garbage collection cycle.

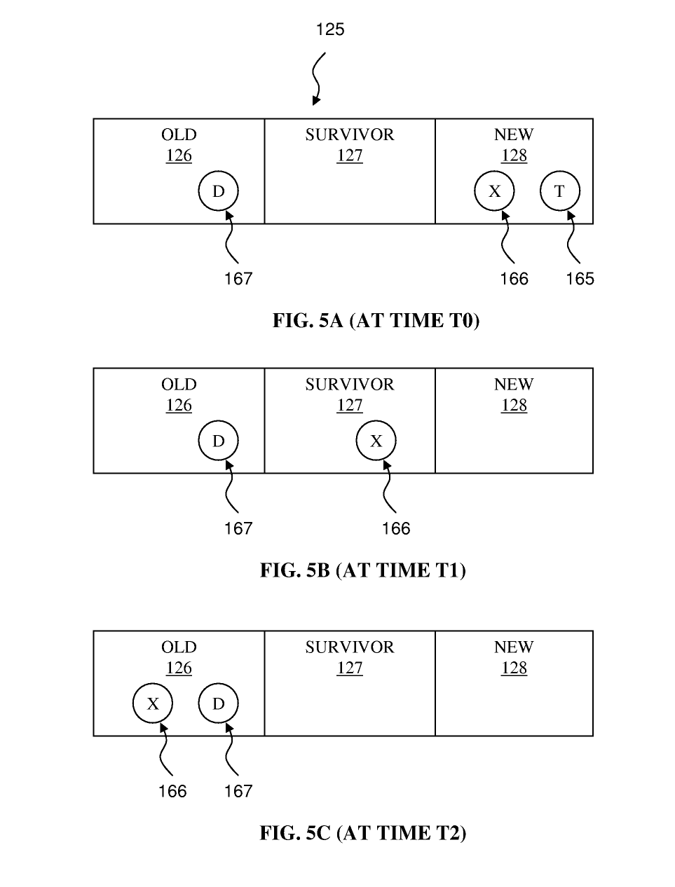

FIGS. 5A, 5B, and 5C illustrate heap layouts for objects created with a respective allocation modifier at time t0, t1, and t2, respectively, in accordance with the embodiments of the present invention.

In FIG. 5A, objects T 165, X 166, and D 167 are created at time t0. The object T 165 is allocated in a “new” area 128 in a heap space 125 because the object T 165 is created with an allocation modifier “temporary,” which indicates that the object T 165 has a short life expectancy and is very likely to be collected in next garbage collection cycle. The object X 166 is also allocated in the “new” area 128 in the heap space 125 because the object X 166 is created without an allocation modifier. The object D 167 is allocated in an “old” area 126 in the heap space 125 because the object D 167 is created with an allocation modifier “durable,” which indicates that the object D 167 has a long life expectancy and there is no need to scan the object D 167 in next garbage collection cycle.

FIG. 5B illustrates objects survived a first garbage collection cycle at time t1. The object T 165 in FIG. 5A, sura, did not survive the first garbage collection cycle and a memory area is freed. The object X 166 has survived the first garbage collection cycle and is relocated to a “survivor” area 127 in the heap space 125. The object D 167 remains in the “old” area 126 without being scanned in the first garbage collection cycle and without being relocated.

FIG. 5C illustrates objects survived a second garbage collection cycle at time t2. The object X 166 has survived the second garbage collection cycle and is relocated to the “old” area 126 in the heap space 125. The object D 167 remains in the “old” area 126 without being scanned in the second garbage collection cycle and without being relocated.

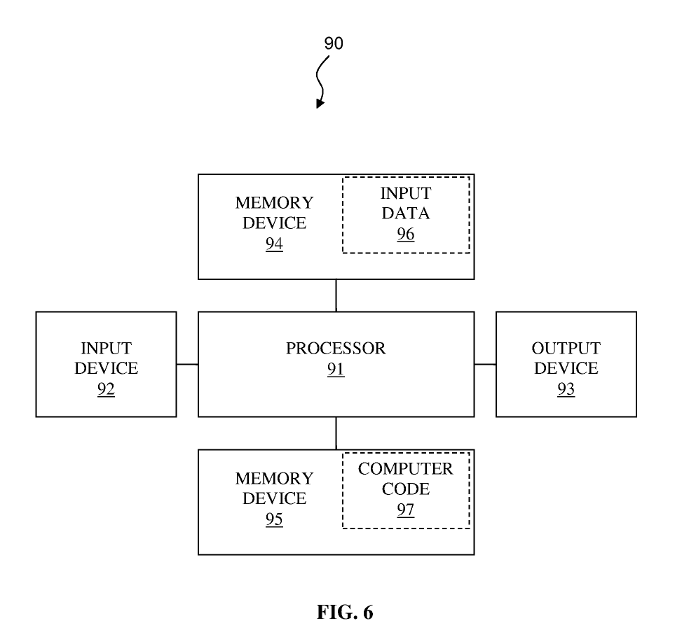

FIG. 6 illustrates a computer system 90 used for optimizing garbage collection with the allocation modifiers, in accordance with the embodiments of the present invention.

The computer system 90 comprises a processor 91, an input device 92 coupled to the processor 91, an output device 93 coupled to the processor 91, and memory devices 94 and 95 each coupled to the processor 91. The input device 92 may be, inter alia, a keyboard, a mouse, a keypad, a touchscreen, a voice recognition device, a sensor, a network interface card (NIC), a Voice/video over Internet Protocol (VOIP) adapter, a wireless adapter, a telephone adapter, a dedicated circuit adapter, etc. The output device 93 may be, inter alia, a printer, a plotter, a computer screen, a magnetic tape, a removable hard disk, a floppy disk, a NIC, a VOIP adapter, a wireless adapter, a telephone adapter, a dedicated circuit adapter, an audio and/or visual signal generator, a light emitting diode (LED), etc. The memory devices 94 and 95 may be, inter alia, a cache, a dynamic random access memory (DRAM), a read-only memory (ROM), a hard disk, a floppy disk, a magnetic tape, an optical storage such as a compact disk (CD) or a digital video disk (DVD), etc. The memory device 95 includes a computer code 97 which is a computer program that comprises computer-executable instructions. The computer code 97 includes, inter alia, an algorithm used for optimizing garbage collection with the allocation modifiers according to the present invention. The processor 91 executes the computer code 97. The memory device 94 includes input data 96. The input data 96 includes input required by the computer code 97. The output device 93 displays output from the computer code 97. Either or both memory devices 94 and 95 (or one or more additional memory devices not shown in FIG. 6) may be used as a computer usable storage medium (or a computer readable storage medium or a program storage device) having a computer readable program embodied therein and/or having other data stored therein, wherein the computer readable program comprises the computer code 97. Generally, a computer program product (or, alternatively, an article of manufacture) of the computer system 90 may comprise said computer usable storage medium (or said program storage device).

While FIG. 6 shows the computer system 90 as a particular configuration of hardware and software, any configuration of hardware and software, as would be known to a person of ordinary skill in the art, may be utilized for the purposes stated supra in conjunction with the particular computer system 90 of FIG. 6. For example, the memory devices 94 and 95 may be portions of a single memory device rather than separate memory devices.

While particular embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A method for optimizing garbage collection, the method comprising:
interpreting an intermediate code comprising a data object declared with an allocation modifier that indicates how long the data object will be used while executing the intermediate code, wherein the allocation modifier is provided by a programmer of a source code which had been compiled into the intermediate code;
determining a heap area for the data object pursuant to the allocation modifier; and
allocating the data object in the determined heap area such that a garbage collector reduces the number of objects to scan during garbage collection and minimizes the number of objects to be relocated from a first heap area to a second heap area, wherein objects in the first heap area are younger than objects in the second heap area,
wherein an interpreter of a runtime environment performs said interpreting, said determining, and said allocating, and wherein the runtime environment comprises the interpreter and the garbage collector.

2. The method of claim 1,
wherein the allocation modifier for the data object in the source code is selected from the group consisting of temporary and durable,
wherein the allocation modifier of temporary denotes that the data object is expected to have a short lifespan and needs to be allocated in a short-term object area, and
wherein the allocation modifier of durable denotes that the data object is expected to have a long lifespan and needs to be allocated in a long-term object area.

3. The method of claim 1,
wherein the allocation modifier for the data object in the source code is selected from the group consisting of short, middle, and long,
wherein the allocation modifier of short denotes that the data object is expected to have a short lifespan and needs to be allocated in a short-term object area,
wherein the allocation modifier of middle denotes that the data object is expected to have a moderate lifespan and needs to be allocated in a survivor area, and
wherein the allocation modifier of long denotes that the data object is expected to have a long lifespan and needs to be allocated in a long-term object area.

4. The method of claim 1, wherein no allocation modifier for the data object in the source code is provided to indicate that a lifespan of the data object is unpredictable and the data object needs to be allocated in a short-term object area where a conventional interpreter allocates all new data objects and the garbage collector scans to discover dead objects for reuse and relocates survived objects to a survivor area.

5. The method of claim 1, wherein the allocation modifier for the data object is determined pursuant to how the data object behaves during execution based on factors comprising a logical flow of the source code, input data, and user interactions.

6. The method of claim 1, wherein the runtime environment is a Java Virtual Machine (JVM) and wherein the intermediate code is a Java bytecode.

7. A computer program product, comprising a computer usable storage medium having a computer readable program code embodied therein, said computer readable program code containing instructions that when executed by a processor of a computer system implement a method for optimizing garbage collection, the method comprising:
interpreting an intermediate code comprising a data object declared with an allocation modifier that indicates how long the data object will be used while executing the intermediate code, wherein the allocation modifier is provided by a programmer of a source code which had been compiled into the intermediate code;
determining a heap area for the data object pursuant to the allocation modifier; and
allocating the data object in the determined heap area such that a garbage collector reduces the number of objects to scan during garbage collection and minimizes the number of objects to be relocated from a first heap area to a second heap area, wherein objects in the first heap area are younger than objects in the second heap area,
wherein an interpreter of a runtime environment performs said interpreting, said determining, and said allocating, and wherein the runtime environment comprises the interpreter and the garbage collector.

8. The computer program product of claim 7,
wherein the allocation modifier for the data object in the source code is selected from the group consisting of temporary and durable,
wherein the allocation modifier of temporary denotes that the data object is expected to have a short lifespan and needs to be allocated in a short-term object area, and
wherein the allocation modifier of durable denotes that the data object is expected to have a long lifespan and needs to be allocated in a long-term object area.

9. The computer program product of claim 7,
wherein the allocation modifier for the data object in the source code is selected from the group consisting of short, middle, and long,
wherein the allocation modifier of short denotes that the data object is expected to have a short lifespan and needs to be allocated in a short-term object area,
wherein the allocation modifier of middle denotes that the data object is expected to have a moderate lifespan and needs to be allocated in a survivor area, and
wherein the allocation modifier of long denotes that the data object is expected to have a long lifespan and needs to be allocated in a long-term object area.

10. The computer program product of claim 7, wherein no allocation modifier for the data object in the source code is provided to indicate that a lifespan of the data object is unpredictable and the data object needs to be allocated in a short-term object area where a conventional interpreter allocates all new data objects and the garbage collector scans to discover dead objects for reuse and relocates survived objects to a survivor area.

11. The computer program product of claim 7, wherein the allocation modifier for the data object is determined pursuant to how the data object behaves during execution based on factors comprising a logical flow of the source code, input data, and user interactions.

12. The computer program product of claim 7, wherein the runtime environment is a Java Virtual Machine (JVM) and wherein the intermediate code is a Java bytecode.

13. A system comprising a processor and a computer readable memory unit coupled to the processor, said memory unit containing instructions that when executed by the processor implement a method for optimizing garbage collection, the method comprising:
interpreting an intermediate code comprising a data object declared with an allocation modifier that indicates how long the data object will be used while executing the intermediate code, wherein the allocation modifier is provided by a programmer of a source code which had been compiled into the intermediate code;
determining a heap area for the data object pursuant to the allocation modifier; and
allocating the data object in the determined heap area such that a garbage collector reduces the number of objects to scan during garbage collection and minimizes the number of objects to be relocated from a first heap area to a second heap area, wherein objects in the first heap area are younger than objects in the second heap area,
wherein an interpreter of a runtime environment performs said interpreting, said determining, and said allocating, and wherein the runtime environment comprises the interpreter and the garbage collector.

14. The system of claim 13,
wherein the allocation modifier for the data object in the source code is selected from the group consisting of temporary and durable,
wherein the allocation modifier of temporary denotes that the data object is expected to have a short lifespan and needs to be allocated in a short-term object area, and
wherein the allocation modifier of durable denotes that the data object is expected to have a long lifespan and needs to be allocated in a long-term object area.

15. The system of claim 13,
wherein the allocation modifier for the data object in the source code is selected from the group consisting of short, middle, and long,
wherein the allocation modifier of short denotes that the data object is expected to have a short lifespan and needs to be allocated in a short-term object area,
wherein the allocation modifier of middle denotes that the data object is expected to have a moderate lifespan and needs to be allocated in a survivor area, and
wherein the allocation modifier of long denotes that the data object is expected to have a long lifespan and needs to be allocated in a long-term object area.

16. The system of claim 13, wherein no allocation modifier for the data object in the source code is provided to indicate that a lifespan of the data object is unpredictable and the data object needs to be allocated in a short-term object area where a conventional interpreter allocates all new data object and the garbage collector frequently scans to discover dead objects for reuse and relocates survived objects to a survivor area.

17. The system of claim 13, wherein the allocation modifier for the data object is determined pursuant to how the data object behaves during execution based on factors comprising a logical flow of the source code, input data, and user interactions.

18. The system of claim 13, wherein the runtime environment is a Java Virtual Machine (JVM) and wherein the intermediate code is a Java bytecode.

19. A method for optimizing garbage collection, the method comprising:
loading a machine code comprising a data object declared with an allocation modifier that indicates how long the data object will be used while executing the machine code, wherein the allocation modifier is provided by a programmer of the source code which had been compiled into the machine code;
determining a heap area for the data object pursuant to the allocation modifier; and
allocating the data object in the determined heap area such that a garbage collector reduces the number of objects to scan during garbage collection and minimizes the number of objects to be relocated from a first heap area to a second heap area, wherein objects in the first heap area are younger than objects in the second heap area,
wherein an execution engine of a runtime environment performs said loading, said determining, and said allocating, and wherein the runtime environment comprises the interpreter and the garbage collector.

20. The method of claim 19, wherein the source code is selected from a group consisting of C program and C++ program.
